(19) United States
(12) Patent Application Publication
(10) Pub. No.: US 2024/0330413 A1
(43) Pub. Date: Oct. 3, 2024

(54) WEIGHTED MACHINE LEARNING AGREEMENT SYSTEM FOR CLASSIFICATION

(71) Applicant: Cisco Technology, Inc., San Jose, CA (US)

(72) Inventors: Mohammed Hamzeh, Woluwe-Saint-Lambert (BE); David C. White, JR., St. Petersburg, FL (US); Christopher Shaun Roberts, Spring, TX (US); Magnus Mortensen, Cary, NC (US); Kevin D. McCabe, Raleigh, NC (US); Felipe De Mello, Holly Springs, NC (US); Deon Anthony Pillsbury, Apex, NC (US)

(21) Appl. No.: 18/192,130

(22) Filed: Mar. 29, 2023

(51) Int. Cl. G06F 18/2415; G06N 20/00; G10L 15/02; G10L 15/06; G10L 15/197

(52) U.S. Cl. CPC G06F 18/2415; G06N 20/00; G10L 15/02; G10L 15/063; G10L 15/197

(57) ABSTRACT

The techniques described herein relate to a method including: providing input to a plurality of prediction models; obtaining an initial prediction from each of the plurality of prediction models; providing the input to one or more weight models; obtaining from the one or more weight models a weight for each initial prediction, wherein the weight for each initial prediction is based upon the input and behavior of each of the plurality of prediction models; and determining an output prediction from the initial predictions and the weights.

### TECHNICAL FIELD

The present disclosure relates to the use and training of machine learning models.

### BACKGROUND

Machine learning models are great tools for predictive analysis, as models may be trained to provide both a prediction and a probability for that prediction. However, it is possible for machine learning models to generate incorrect predictions (also referred to as false positives or false negatives). The probability of receiving an inaccurate prediction may reach up to 20-30% depending on the quality of the model. At the same time, machine learning models do not always provide a high probability output (e.g., probabilities of 98% or above). The percentage of these high probability predictions is low, often around 1% of the total number of predictions.

### BRIEF DESCRIPTION OF THE DRAWINGS

FIG. 1 is a first example system configured to implement the weighted machine learning techniques of this disclosure, according to an example embodiment.

FIG. 2 is a second example system configured to implement the disclosed weighted machine learning techniques, according to an example embodiment.

FIG. 3 illustrates a process for training prediction models using the disclosed weighted machine learning techniques, according to an example embodiment.

FIG. 4 illustrates a process for generating an optimized dataset used in training of weight models of the disclosed techniques, according to an example embodiment.

FIG. 5 illustrates a process for training weight models using the disclosed weighted machine learning techniques, according to an example embodiment.

FIG. 6 is a system in which multiple machine learning groups, each fed with different features of the same input data, implement the disclosed weighted machine learning techniques, according to an example embodiment.

FIG. 7 is a flowchart providing a process flow for implementing the use of the prediction and weight models of the disclosed weighted machine learning techniques, according to an example embodiment.

FIG. 8 is a flowchart providing a process flow for training weight models of the disclosed weighted machine learning techniques, according to an example embodiment.

FIG. 9 is a functional block diagram of a processing device configured to implement the disclosed weighted machine learning techniques, according to an example embodiment.

### DETAILED DESCRIPTION

### Overview

In some aspects, the techniques described herein relate to a method including: providing input to a plurality of prediction models; obtaining an initial prediction from each of the plurality of prediction models; providing the input to one or more weight models; obtaining from the one or more weight models a weight for each initial prediction, wherein the weight for each initial prediction is based upon the input and behavior of each of the plurality of prediction models; and determining an output prediction from the initial predictions and the weights.

In some aspects, the techniques described herein relate to a method including: providing an input to a plurality of prediction models; obtaining, for the input, a prediction from each of the plurality of prediction models; determining a weight for each prediction from the plurality of prediction models; generating a training dataset including the input labeled with the weights for each of the predictions from the plurality of prediction models; and training a weight model using the training dataset.

In some aspects, the techniques described herein relate to one or more tangible, non-transitory computer readable storage media encoded with instructions that, when executed by one or more processors, cause the one or more processors to: provide input to a plurality of prediction models; obtain an initial prediction from each of the plurality of prediction models; provide the input to one or more weight models; obtain from the one or more weight models a weight for each initial prediction, wherein the weight for each initial prediction is based upon the input and behavior of each of the plurality of prediction models; and determine an output prediction from the initial predictions and the weights.

### Example Embodiments

Machine learning models are used to provide numerous types of predictions or provide responses to numerous types of data. For example, machine learning models may be used in customer relationship or customer management systems to provide responses to or instructions for responding to customer inquiries, problems and questions. For example, a machine learning model may be trained to analyze a customer's response and determine the next action to take in response thereto. However, using related art techniques it may be difficult to ensure that the action provided by the machine learning model is 100% right in its actions and decisions. Because of this, humans may be used to watch over machine learning model responses to ensure the responses are correct. This human oversight is very wasteful of human time and contrary to the intent of using a machine learning model in the first place.

Thus, the techniques disclosed herein provide techniques that allow example machine learning systems to improve themselves and determine when the example machine learning systems should take automated actions without human oversight or intervention. Additionally, the disclosed techniques may significantly increase the correct number of machine learning model responses with predicted probabilities that are above 98%. By implementing the disclosed techniques, some example machine learning models have shown a 500% increase in high probability predictions (i.e., predictions with probabilities greater than 98%). This increase in high probability predictions results in a dramatically larger number of actions that the machine learning models take without any human oversight. These examples, and the example machine learning models discussed below, are described using customer response machine learning models. However, the disclosed techniques may be applicable to any machine learning model that provides predictions and associated probabilities for the predictions.

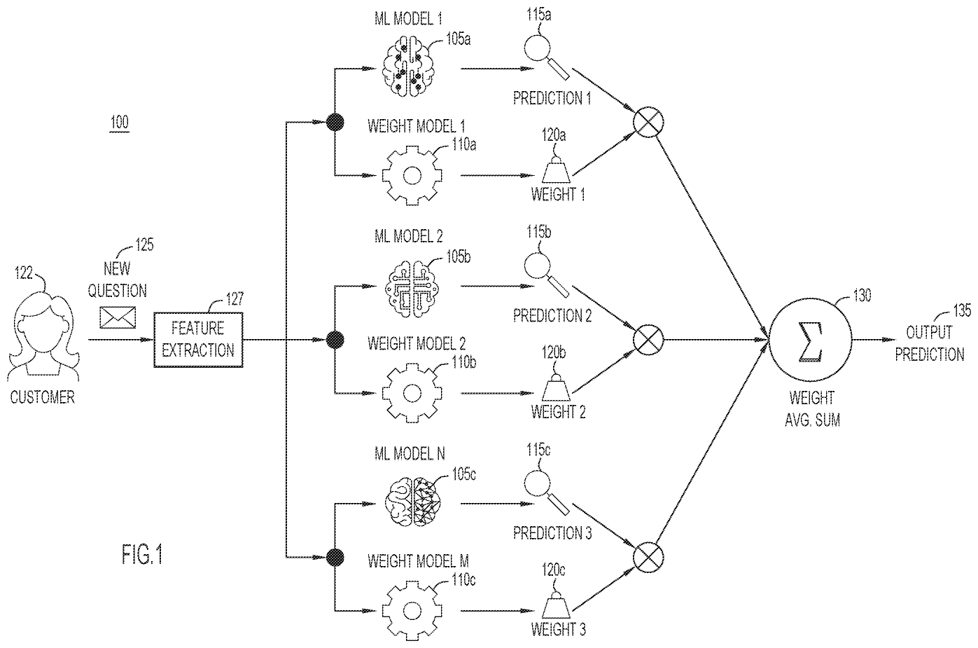

One goal of the techniques disclosed herein is to significantly increase the number of high-probability predictions output by the machine learning system in order to increase the number of fully automated actions without the need for human monitoring or overwatch. This may be achieved through machine learning system 100 of FIG. 1. Included in machine learning system 100 are a plurality of machine learning prediction models 105a-c and associated weight models 110a, 110b and 110c (110a-c). Each of prediction models 105a-c provides a predicted response in the form or predictions 115a, 115b, and 115c (115a-c) to question 125, while weight models 110a-c provide a weight 120a-c for the predicted responses 115a-c, respectively. The weights 120a-c are then used to determine a weight average sum 130 from which output prediction 135 is derived.

The weights 120a-c provided by weight models 110a-c should not be confused with a probability included as part of the predictions 115a-c provided by prediction models 105a-c. Weights 120a-c indicate how to weight the predictions 115a-c relative to each other, where the probabilities included in predictions 115a-c provide a confidence level for the prediction itself. For example, prediction 115a may include a probability of 98% that its prediction is correct, and prediction 115b may include the same 98% probability that its prediction is correct. Weights 120a and 120b, on the other hand, indicate how to weight these probabilities relative to each other. For example, if weight 120a provides a value of 1.01 and weight 120b provides a weight of 1.42, prediction 115b will be weighted more heavily in weight average sum 130 compared with prediction 115a even though prediction models 105a and 105b provide the same 98% probability. According to another example, prediction 115a may be provided with a probability of 98%, while prediction 115b is provided with a 70% probability. If weight 120a has a value of 1.01 and weight 120b has a value of 1.42, prediction 115b may be selected for output prediction 135 as weight 120b will increase the prediction 115b probability from 70% to 99% (i.e., 1.42×70%=99%).

As will become clear when the training of weight models 110a-c is described below, each of weight models 110a-c is trained with insight into the outputs of all of prediction models 105a-c, allowing weight models 110a-c to weight the prediction of one prediction model against the prediction of the other prediction models.

System 100 is configured as part of a customer relationship system in which a customer 122 poses question 125. In general, system 100 implements a three step process as follows:
Step 1: Input is passed to prediction models 105a-c which provide an output as predictions 115a-c. For example, the output of prediction models 105a-c may be embodied as a probability description vector that represents the prediction output.
Step 2: The same input provided to the prediction models 105a-c is also provided to weight models 110a-c which output weights 120a-c. Weights 120a-c may be embodied as weight vectors.
Step 3: The predictions 115a-c are multiplied by weights 120a-c, respectively, to generate weight average sum 130.

In other words, the disclosed techniques provide a method and system which examines the input intended to be sent to a number of machine learning models, and based on that input it determines how likely a given model will be to predict the correct response. The systems and methods then apply this prediction to the output of the given model in order to weight that output more accurately against that own model's prediction and probability result. This then allows the systems and methods to select the most likely correct answer from a plethora of machine learning model outputs, significantly improving the accuracy of the machine learning results.

Furthermore, by using a plurality of prediction models alongside a plurality of weight models the system and methods are able to combine the strengths and weaknesses of the different machine learning models to weed out issues any individual model might exhibit against a given input. Accordingly, the disclosed techniques leverage the highest level of statistical averages across multiple models and multiple datasets.

The techniques may be applied to imagery or other data inputs. In short, the disclosed techniques allow users to leverage multiple different machine learning models and have the system of models determine the best answer (e.g., the most accurate answer) by augmenting the accuracy result of each model with the weights provided by the weight models.

According to the specific example of FIG. 1, system 100 implements this three-step process as follows. First, an input is provided, which in the example of FIG. 1 is a question 125 provided by user or customer 122. Feature extraction process 127 extracts features from question 125 and provides the features to prediction models 105a-c and weight models 110a-c. A plurality of prediction models 105a-c may be used in system 100 because different prediction models 105a-c may be trained such that they are better at addressing different types of input. For example, prediction model 105a may perform better on short text questions, while prediction model 105b may better handle complicated long text questions. By providing the features extracted from question 125 to a plurality of models 105a-c, system 100 may ensure that output prediction 135 more accurately provides the best possible output for the particular question. In particular, the weights 120a-c providing by weight models 110a-c allow system 100 to appropriately weight predictions 115a-c to provide a more accurate output prediction 135.

According to a more specific example, prediction models 105a-c may provide predictions 115a-c as prediction vectors C having the following form:

C=[P₀(Answer 0),P₁(Answer 1) . . . Pₖ(Answer k)] (1);

where C is the output which is a set of answers 1-k with associated probabilities P₁-Pₖ.

In one specific example, there may be 3 different answers on which prediction models 105a-c have been trained, which have the following values:
answer 0: close_case
answer 1: escalate_case
answer 3: on_hold

The predictions 115a-c provided by models 105a-c may have the following form:
Prediction 115a; prediction vector C1=[0.8, 0.1, 0.1]
Prediction 115b: prediction vector C2=[0.7, 0.2, 0.1]
Prediction 115c: prediction vector C3=[0.6, 0.2, 0.2]

Accordingly, prediction model 105a would predict the “close case” answer class with 80% probability, the “escalate case” answer class with a 10% probability, and the “on hold” answer class also with a 10% probability. Prediction model 105b, on the other hand, would predict the “close case” answer class with 70% probability, the “escalate case” answer class with a 20% probability, and the “on hold” answer class with a 10% probability. Finally, prediction model 105c would predict the “close case” answer class with 60% probability, the “escalate case” answer class with a 20% probability, and the “on hold” answer class also with a 20% probability.

As also explained above, weight models 110a-c weight the outputs of prediction models 105a-c. According to specific examples, weights 120a-c may take the form of weight vectors W that may be used to weight the output vectors C. When implemented in conjunction with output vectors C, the weight vector W may have k elements, and each element corresponds to a specific class (or answer), where W=[W₀, W₁, . . . Wₖ]. After the prediction C from a specific model is acquired, C is multiplied by W to determine a per-answer weighted output OW:

OW=[P(Answer 0)*W0,P(Answer 1)*W1, . . . ,P(Answer n)*Wn] (2).

Provided below are example weights 120a-c that are provided in the form of weight vectors W:
Weight 120a: weight vector weight W1=[1.1, 0.9, 0.9]
Weight 120b: weight vector weight W2=[1.2, 0.8, 0.7]
Weight 120c: weight vector weight W3=[1.4, 0.6, 0.5]

The per answer weighted outputs per model will be:
WO1=[0.8*1.1, 0.1*0.9,0.1*0.9]=[0.88, 0.09, 0.09]
WO2=[0.7*1.2, 0.2*0.8, 0.1*0.7]=[0.84, 0.16, 0.07]
WO2=[0.6*1.4, 0.2*0.6, 0.2*0.5]=[0.84, 0.12, 0.10]

As for the weight average sum 130, which may be designated WA, it will be a sum of the WO values divided by the number of models m:

WA=sum(OW)/m (3).

In this example m=3, so the weight average sum 130 will be:

WA=[(0.88+0.84+0.84)/3,(0.09+0.16+0.12)/3,(0.09+0.07+0.1)/3]=[0.85,0.123,0.09] (4).

Depending on the specific example, the output of weight average sum 130 may be consolidated into one prediction and outputted as output prediction 135. Alternatively, the output of each individual model can be evaluated, and if a majority of the models voted on a specific class with a high average probability, then that specific class is output as output prediction 135 and an automated action can be taken directly based on that group's vote. According to still other examples, the prediction with the highest value in the weight average sum 130 may be provided as the output prediction 135. In this case, 0.85 associated with the “close case” answer is the highest value, and therefore, “close case” would be provided as output prediction 135. In another example system, the model whose prediction is assigned the highest weight would be selected Using the values above, the weight of “1.4” in weight vector W3 from weight 120c would result in the “close case” prediction being provided as the output prediction 135.

In addition to weighting the predictions provided by prediction models 105a-c, the weights 120a-c may also be used to evaluate how well prediction models 105a-c are performing. If during the inference a particular prediction model or class becomes too low or too biased for the dataset, it may be determined that that model is not performing well. Accordingly, that particular model's predictions may be removed from the determination of weight average sum 130 for one or more classes. This will in effect “drop out” that prediction model or class from affecting weight average sum 130. A particularly low performing prediction model may also be removed from system 100 altogether.

During testing and in production implementations of the disclosed techniques, a five times increase in predictions with high probability (i.e., probabilities greater than 98%) has been observed, which allowed the systems implementing the disclosed techniques to perform five times more automated actions without human intervention. This increase in automated actions was achieved while keeping the percentage of incorrect predictions at the same level as the models that did not implement the disclosed techniques.

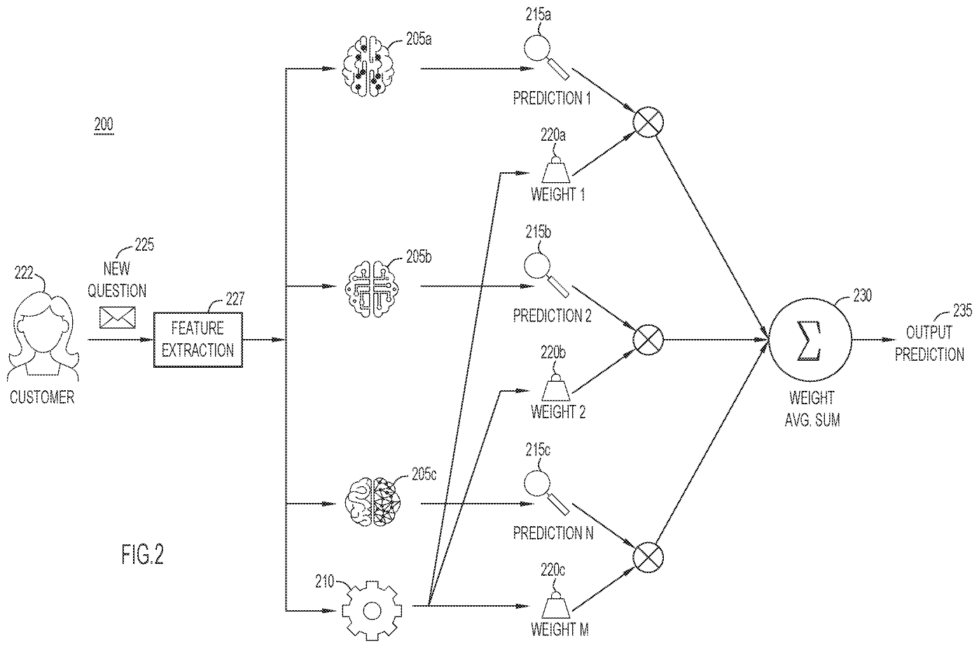

Turning to FIG. 2, depicted therein is another example system 200 of the disclosed techniques in which a single weight model 210 is used to provide weights 220a-c. Similar to system 100 of FIG. 1, in system 200 a user or customer 222 presents a question 225. Feature extraction process 227 extracts features from question 225 and provides them to prediction models 205a, 205b, and 205c (205a-c). However, where system 100 provides the features to a plurality of weight models 110a-c, system 200 includes a single weight model 210 that is configured to provide respective weights 220a, 220b and 220c (220a-c) for each of prediction models 205a-c that are used to weight predictions 215a, 215b, and 215c (215a-c) when determining weight average sum 230. Like output prediction 135 of FIG. 1, system 200 provides output prediction 235.

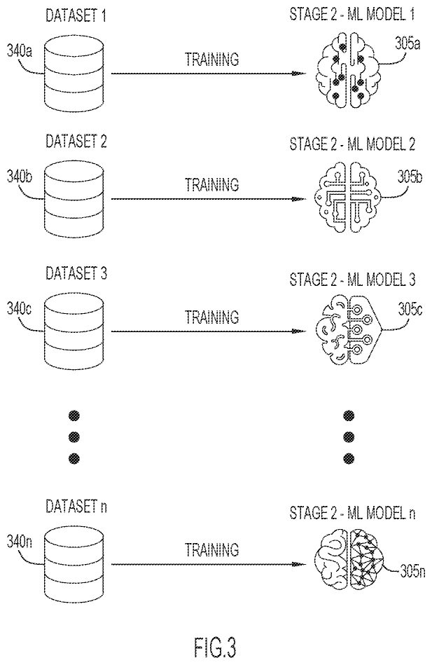

As indicated above, implementing a system like system 100 of FIG. 1 or system 200 of FIG. 2 includes the training of prediction models 105a-c/205a-c and weight models 110a-c/210. According to the disclosed techniques, the prediction models 105a-c/205a-c may be trained first, and once trained, these models may be used to create a training dataset that is used to train weight models 110a-c/210, as will now be described with reference to FIGS. 3-5.

The main approach in training the prediction models according to the disclosed techniques is to create several datasets around the same problem domain, each dataset containing text samples that play to the strengths of a specific model. If the model performs better on small text, then the dataset used to train that model will consist of smaller, more simple texts. If another model can handle complicated long text better, then the training dataset will be optimized with those complex samples. Accordingly, training datasets 340a, 340b, 340c, . . . 340n (340a-n) contain data configured to train 305a, 305b, 305c, . . . 305n (305a-n) to perform better for the specific data contained in each of the datasets.

For example, as illustrated in FIG. 3, training dataset 340a may contain text samples with smaller, simpler text, which will train prediction model 305a to perform better on these types of input. Training dataset 340b, on the other hand, may include complicated, long text data, and therefore, prediction model 305b will be trained to perform better on longer, more complicated input text data. Training dataset 340c may include text with special characters, resulting in prediction model 305c being trained to perform better on input that includes special characters. Accordingly, each of training datasets 304a-n may be configured to train prediction models 305a-n with different strengths. The output of prediction models 305a-n may take the form of equation 1 described above with reference to FIGS. 1 and 2.

While training datasets 340a-n may include data with some different characteristics, the structure of the data contained within training datasets 340a-n will be similar, allowing prediction models 305a-n to receive and make predictions on the same input. For customer response use cases, like those described above with reference to FIGS. 1 and 2, the training data may include question and answer pairs. However, the skilled artisan will understand that the disclosed techniques are not limited to question and answer training and input data, nor are they limited to customer response use cases. Instead, the skilled artisan will understand that the disclosed techniques are broadly applicable to use cases in which machine learning or artificial intelligence techniques are used to provide an “answer” such as a prediction. For example, the disclosed techniques may be broadly applied to use cases in which machine learning models are used to predict airline ticket prices given certain assumptions (e.g., a specific time interval, current sales of tickets, fuel costs, etc.), use cases in which machine learning models are used to predict a stock price based upon particular events (e.g., related company stock price changes, world events, interest rate changes, a product release, etc.), or use cases in which machine learning models are used to predict traffic density based upon given circumstances (e.g., a time interval, an accident, weather conditions, etc.), among others.

The training of prediction models 305a-n may be implemented through what is essentially a three-step process. The process would begin with each of training datasets 340a-n being split into a first portion used to train the prediction models 305a-n and a second portion used to test the performance of the trained models 305a-n. The process continues with the first portions of training dataset 340a-n being used to train prediction models 305a-n, respectively. Once the prediction models 305a-n are trained, the second portions of training datasets 340a-n are used to measure the initial performance of prediction models 305a-n, respectively. Based upon the initial performance of models 305a-n, the models may be retrained as needed or dropped from use in systems 100 and 200 of FIGS. 1 and 2, respectively.

After training, prediction models 305a-n predict the same number set of answers (e.g., the same answer classes), and the output of each model may be a probability distribution vector presenting the probability of each class.

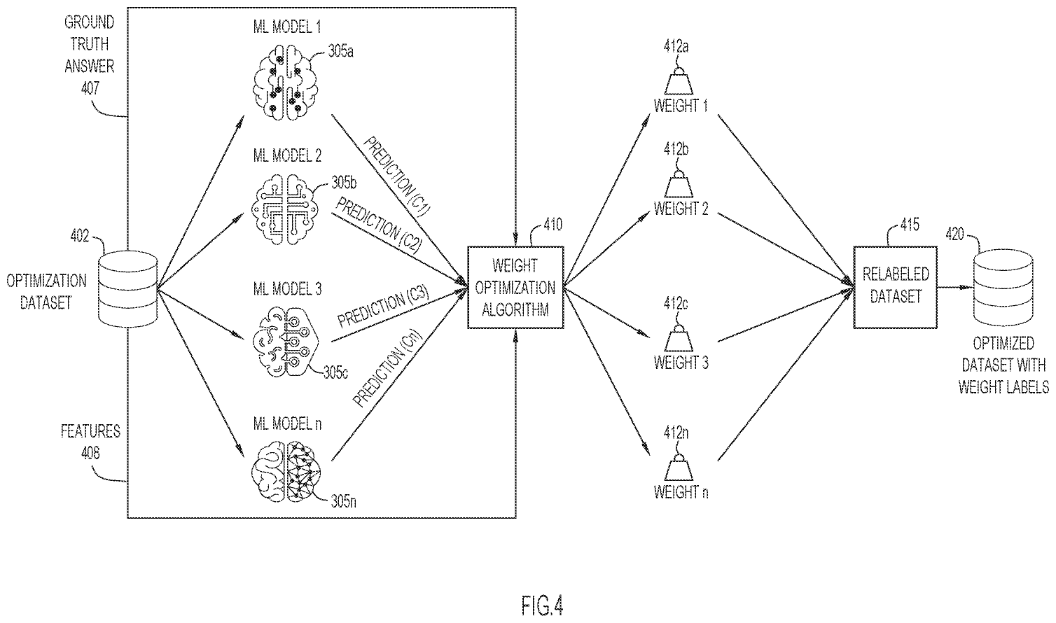

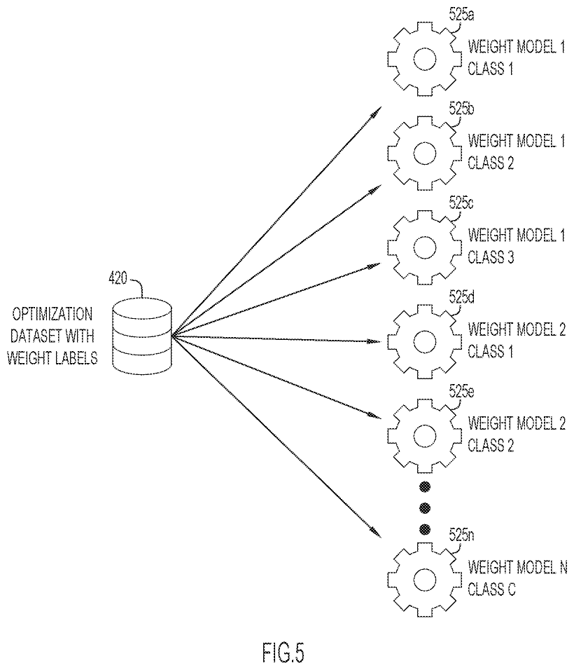

Once the prediction models 305a-n are trained they may be used to generate an optimization weight training dataset. This optimization weight training dataset is then used to train weight models, such as weight models 110a-c/210 of FIGS. 1 and 2. This process will now be described with reference to FIGS. 4 and 5.

As illustrated in FIG. 4, the process of training the weight models begins with an optimization dataset 402. This dataset contains labeled samples from all the different datasets used to train the prediction models 305a-n, and the samples in this dataset should not be part of any training dataset 340a-n of FIG. 3. In other words, optimization dataset 402 may be constructed by removing samples from training datasets 340a-n prior to the training of prediction models 305a-n, and combining these samples into optimization dataset 402. This optimization dataset 402 may be as big as one or more of training datasets 340a-n.

Also illustrated in FIG. 4 is weight optimization algorithm 410, which takes in three main inputs:
The unweighted predictions of each of the prediction models 305a-n. These unweighted predictions are generated by passing features extracted from the weight optimization dataset 402 through the prediction models 305a-n.
Ground truth answers from each of the samples in weight optimization dataset 402.
Features 408 extracted from the weight optimization dataset 402.

The weight optimization algorithm 410 searches within the weight space and identifies weights 412a, 412b, 412c, . . . 412n (412a-n). The weights 412a-n should minimize the difference between the average sum of the predictions from prediction models 305a-n and the ground truth answers 407 for a correct prediction and maximize the difference between the average sum of the predictions from prediction models 305a-n and the ground truth answers 407 for incorrect predictions. Accordingly, the weight optimization algorithm 410 may identify weights 412a-n that maximize the group input. Weight optimization algorithm 410 may use any known optimization technique to identify the weights 412a-n. For example, gradient descent or simulated annealing techniques may be used. Another approach to identifying weights 412a-n is to use neural networks, including single-layer and multi-layer neural networks. For example, in certain implementations, a single-layer or multi-layer neural network may be used to learn the weights 412a-n.

Once the weights 412a-n are identified, the optimization dataset 402 is labeled with weights 412a-n in labelling operation 415 to form labeled optimization dataset 420. Labeled optimization dataset 420 is used train weight models that can predict the weights based on input data, as illustrated in FIG. 5.

As illustrated in FIG. 5, labeled optimization dataset 420 is used to train weight models 525a, 525b, 525c, 525d, 525e, . . . 525n (525a-n) to predict the weight that should be provided in order to maximize the accuracy of the prediction from the group of prediction models 305a-n. Different approaches can be used to train the weight prediction models 525a-n. For example, in FIG. 5 a different weight model 525a-n is trained for each prediction model to be used in the live environment. An example of such an environment would be system 100 of FIG. 1. According to other examples, a single weight model may be trained that provides weights for each of the prediction models used in the live environment. An example of such a system would be system 200 of FIG. 2. In other examples, a greater number of weight models may be trained than predictive models. For example, in system 100 there are three prediction models 105a-c and three weight models 110a-c. However, as described above, weight models 110a-c each provide a weight vectors W that includes three weights, one weight for each of the “close case,” “escalate case” and “on hold” classes of responses. Instead of training a single weight model that provides the weights for each class, individual weight models may be trained for each class. According to this example, M number of weight models will be trained, where M=No. Of Prediction models (N)*Number of classes (C). In the example of FIG. 1, three prediction models were used each with 3 classes, therefore the total number of weight models trained would be 9.

Regardless of which training process is implemented, optimization dataset 420 may be used because the training data is labeled with weights for each of the predictive models. Accordingly, optimization dataset 420 provides a ground truth for the weights of all of the predictive models.

Now that 2 types of models have been created (prediction models 305a-n of FIG. 3 and weight models 525a-n of FIG. 5), new data may be passed into the prediction models and the weight models through systems such as systems 100 and 200 of FIGS. 1 and 2, respectively.

Overall model weights may be used as a performance indicator that indicates how well a particular prediction model is performing. If the model weights are low for one or all classes, it is an indicator of a poorly performing model. If the model weights are high for one or more classes, it may mean that the prediction model is performing very well on the dataset. Accordingly, during training, the weight models 525a-n may be used to evaluate how the prediction models 305a-n are performing. If the weights for a certain prediction model and one or all its classes are below a certain threshold (e.g., 0.01 for example) of acceptance, those prediction models may be dropped from the total of the prediction model view. In other words, the model may be omitted from system 100 or system 200 of FIGS. 1 and 2, respectively. The omission of a prediction model may be implemented by simply setting the weights provided by the prediction model's weight model to always be zero for a particular class. During a time of training or processing of a particular model or class, these drops can further initiate a re-balancing of the weight average sum across the system.

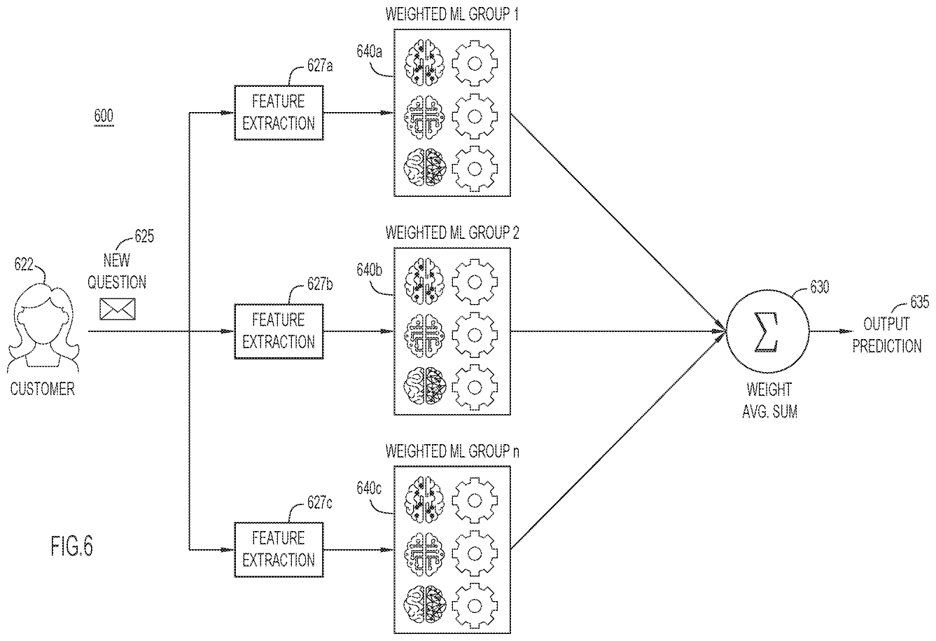

As illustrated in FIGS. 1 and 2, feature extraction 127/227 is the first step in implementing the disclosed systems. Therefore, feature extraction has a huge impact on the performance of machine learning algorithms—the more diverse and comprehensive the extracted features, the better the predictions from the prediction models 105a-c/205a-c. Accordingly, illustrated in FIG. 6 is a system 600 in which multiple feature extractors 627a, 627b and 627c (627a-c) are used to extract features from input data 625 in the form of a question posed by user or customer 622. Different features are then provided to multiple weighted machine learning groups 640a, 640b and 640c (640a-c). Each of weighted machine learning groups 640a-c includes a plurality of prediction models and corresponding weight models. Each of machine learning groups 640a-c is configured like the combination of prediction models 105a-c and weight models 110a-c of FIG. 1 or like the combination of prediction models 205a-c and weight model 210 of FIG. 2. The models in machine learning groups 640a-c will be trained using different features extracted from their respective training datasets. The outputs of machine learning groups 640a-c are combined via weight average sum 630 from which output prediction 635 is derived.

System 600 leverages more diverse and comprehensive extracted features to provide for more accurate predictions. This implementation will result in more diverse features and different insights being learned by each one of the machine learning groups 640a-c. The weights determined in each machine learning group 640a-c will control which machine learning group 640a-c and/or feature extractor 627a-c is a better fit for input data 625.

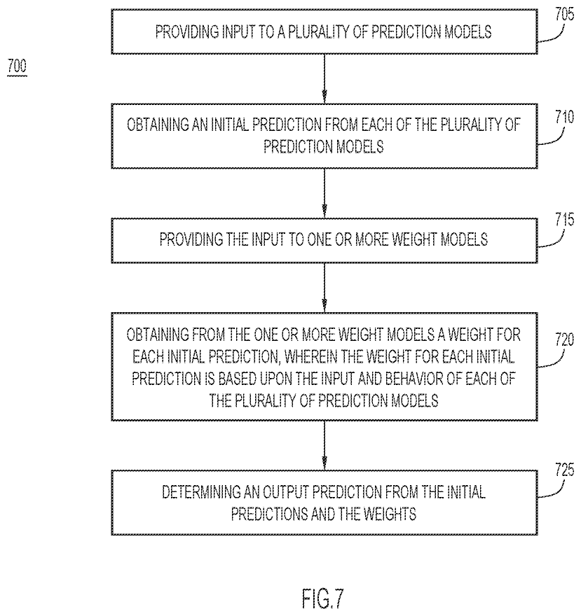

With reference to FIG. 7, depicted therein is a generalized process flow for implementing the prediction aspects of the disclose techniques. For example, the process flow provided in flowchart 700 of FIG. 7 may be used to implement system 100 of FIG. 1 or system 200 of FIG. 2.

Flowchart 700 begins in operation 705 in which an input is provided to a plurality of prediction models. Accordingly, operation 705 may be embodied by the output of feature extraction process 127 of FIG. 1 being provided to prediction models 105a-c. Similarly, operation 705 may be embodied as the output of feature extraction process 227 being provided to prediction models 205a-c.

Flowchart 700 continues in operation 710 in which an initial prediction is obtained from each of the plurality of prediction models. For example, operation 710 may be embodied as the determination of predictions 115a-c of FIG. 1 or the determination of predictions 215a-c of FIG. 2.

In operation 715, the input provided to the prediction models in operation 705 is also provide to one or more weight models. Accordingly, operation 715 may be embodied by the output of feature extraction process 127 of FIG. 1 being provided to weight models 110a-c or by the output of feature extraction process 227 of FIG. 2 being provided to weight model 210.

Next, in operation 720, a weight for each initial prediction is obtained from the one or more weight models. In operation 720, the weight for each initial prediction is based upon the input provided to the one or more weight models and behavior of each of the plurality of prediction models. For example, as described above with reference to FIGS. 3-5, the weight models of the disclosed techniques are trained based on weight values determined by an algorithm, weight optimization algorithm 410 of FIG. 4, that evaluates the predictions provided by all of the prediction models 305a-n. Accordingly, weights provided by the weight models in the disclosed techniques are based upon the behavior of the prediction models.

Finally, in operation 725, an output prediction is determined from the initial predictions and the weights. For example, operation 725 may be embodied as the determination of output prediction 135 of FIG. 1 or output prediction 235 of FIG. 2.

As understood by the skilled artisan, the process flow of flowchart 700 may include more or fewer operations without deviating from the techniques of this disclosure. For example, flowchart 700 may be embodied as the process provided by just one of machine learning groups 640a-c of FIG. 6. As illustrated in FIG. 6, the processes of the disclosed technique may include multiple implementations of flowchart 700, each in a different machine learning group.

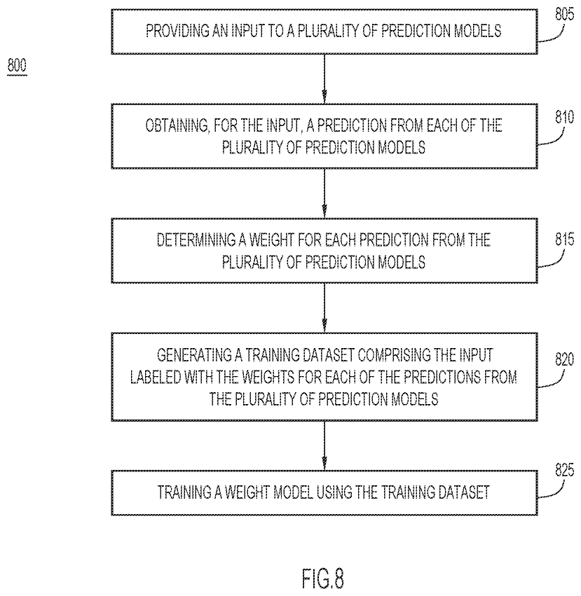

Turning to FIG. 8, depicted therein is a generalized process flow for implementing the weight model training aspects of the disclose techniques. For example, the process flow provided in flowchart 800 of FIG. 8 may be used to implement the training process illustrated in FIGS. 4 and 5 of this disclosure.

Flowchart 800 begins in operation 805 in which an input is provided to a plurality of prediction models. Accordingly, operation 805 may be embodied as some or all of the data in optimization data set 402 being provided to prediction models 305a-n of FIG. 4.

Next, in operation 810, a prediction for the input is obtained from each of the plurality of prediction models. For example, operation 810 may be embodied as the determination of the predictions by prediction models 305a-n of FIG. 4.

Next, in operation 815, a weight is determined for each prediction from the plurality of prediction models. Accordingly, operation 815 may be embodied in the execution of weight optimization algorithm 410 of FIG. 4 against the outputs of prediction models 305a-n.

Flowchart 800 continues in operation 820 in which a training dataset that includes the input labeled with the weights is generated for each of the predictions from the plurality of prediction models. Accordingly, operation 820 may be embodied by the generation of optimization data set 420 as illustrated in FIG. 4.

Finally, flowchart 800 concludes in operation 825 where a weight model is trained using the training dataset. Accordingly, operation 825 may be embodied as the training of one or more of weight models 525a-n, as illustrated in FIG. 5.

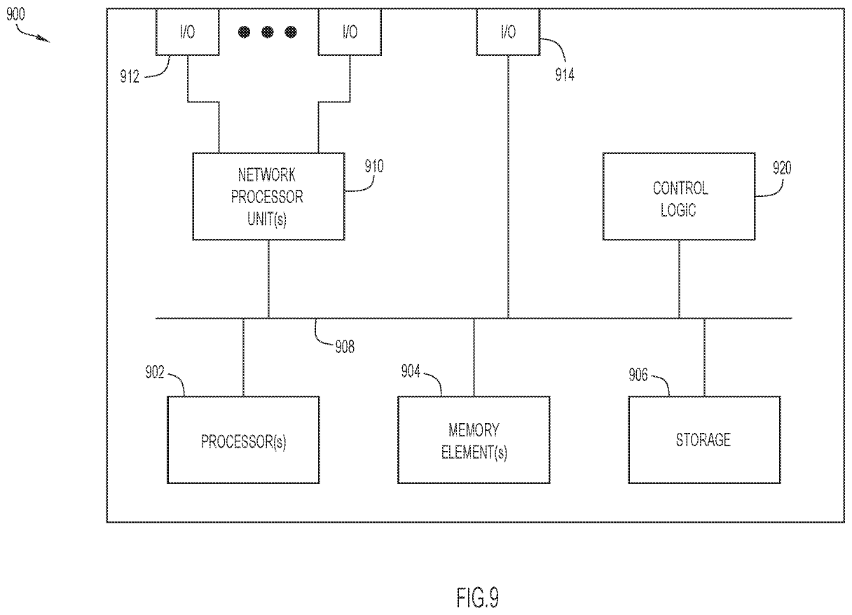

Referring to FIG. 9, FIG. 9 illustrates a hardware block diagram of a computing device 900 that may perform functions associated with operations discussed herein in connection with the techniques depicted in FIGS. 1-8. In various embodiments, a computing device or apparatus, such as computing device 900 or any combination of computing devices 900, may be configured as any entity/entities as discussed for the techniques depicted in connection with FIGS. 1-8 in order to perform operations of the various techniques discussed herein.

In at least one embodiment, the computing device 900 may be any apparatus that may include one or more processor(s) 902, one or more memory element(s) 904, storage 906, a bus 908, one or more network processor unit(s) 910 interconnected with one or more network input/output (I/O) interface(s) 912, one or more I/O interface(s) 914, and control logic 920. In various embodiments, instructions associated with logic for computing device 900 can overlap in any manner and are not limited to the specific allocation of instructions and/or operations described herein.

In at least one embodiment, processor(s) 902 is/are at least one hardware processor configured to execute various tasks, operations and/or functions for computing device 900 as described herein according to software and/or instructions configured for computing device 900. Processor(s) 902 (e.g., a hardware processor) can execute any type of instructions associated with data to achieve the operations detailed herein. In one example, processor(s) 902 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 904 and/or storage 906 is/are configured to store data, information, software, and/or instructions associated with computing device 900, and/or logic configured for memory element(s) 904 and/or storage 906. For example, any logic described herein (e.g., control logic 920) can, in various embodiments, be stored for computing device 900 using any combination of memory element(s) 904 and/or storage 906. Note that in some embodiments, storage 906 can be consolidated with memory element(s) 904 (or vice versa), or can overlap/exist in any other suitable manner.

In at least one embodiment, bus 908 can be configured as an interface that enables one or more elements of computing device 900 to communicate in order to exchange information and/or data. Bus 908 can be implemented with any architecture designed for passing control, data and/or information between processors, memory elements/storage, peripheral devices, and/or any other hardware and/or software components that may be configured for computing device 900. In at least one embodiment, bus 908 may be implemented as a fast kernel-hosted interconnect, potentially using shared memory between processes (e.g., logic), which can enable efficient communication paths between the processes.

In various embodiments, network processor unit(s) 910 may enable communication between computing device 900 and other systems, entities, etc., via network I/O interface(s) 912 (wired and/or wireless) to facilitate operations discussed for various embodiments described herein. In various embodiments, network processor unit(s) 910 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 900 and other systems, entities, etc. to facilitate operations for various embodiments described herein. In various embodiments, network I/O interface(s) 912 can be configured as one or more Ethernet port(s), Fibre Channel ports, any other I/O port(s), and/or antenna(s)/antenna array(s) now known or hereafter developed. Thus, the network processor unit(s) 910 and/or network I/O interface(s) 912 may include suitable interfaces for receiving, transmitting, and/or otherwise communicating data and/or information in a network environment.

I/O interface(s) 914 allow for input and output of data and/or information with other entities that may be connected to computing device 900. For example, I/O interface(s) 914 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 920 can include instructions that, when executed, cause processor(s) 902 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 920) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 904 and/or storage 906 can store data, software, code, instructions (e.g., processor instructions), logic, parameters, combinations thereof, and/or the like used for operations described herein. This includes memory element(s) 904 and/or storage 906 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity, and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source, and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data, or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’. ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of can be represented using the’(s)′ nomenclature (e.g., one or more element(s)).

In summary, the techniques disclosed herein provide for methods and systems that examine the input intended to be sent to a number of machine learning models, and based on that input, determine how likely a given model will be to provide the correct output or prediction. The methods and systems then provide this prediction to the output of the given model in order to weight that output more accurately against that own model's prediction and probability result. This then allows the methods and systems to select the most likely correct answer from a plethora of machine learning models, significantly improving the accuracy of the machine learning results.

Furthermore, by taking N models alongside M weights, the methods and systems combine the strengths and weaknesses of N number of machine learning models and thusly weed out issues any individual model might possess against a given input. This allows the methods and systems to leverage the highest level of statistical averages across multiple models and multiple datasets.

The techniques may be applied to imagery or other data inputs. In short, provided for are methods and systems allowing users to leverage multiple different machine learning models and have the methods and systems determine the best answer (e.g., the most accurate answer) by augmenting the accuracy result of each model.

Accordingly, in some aspects, the techniques described herein relate to a method including: providing input to a plurality of prediction models; obtaining an initial prediction from each of the plurality of prediction models; providing the input to one or more weight models; obtaining from the one or more weight models a weight for each initial prediction, wherein the weight for each initial prediction is based upon the input and behavior of each of the plurality of prediction models; and determining an output prediction from the initial predictions and the weights.

In some aspects, the techniques described herein relate to a method, wherein each of the plurality of prediction models includes a machine learning model.

In some aspects, the techniques described herein relate to a method, wherein the one or more weight models includes a machine learning model.

In some aspects, the techniques described herein relate to a method, wherein determining the output prediction includes determining a plurality of weighted predictions by weighting each of the initial predictions with the respective weight for the initial prediction.

In some aspects, the techniques described herein relate to a method, wherein the output prediction includes all of the weighted predictions.

In some aspects, the techniques described herein relate to a method, wherein the output prediction includes one of the weighted predictions.

In some aspects, the techniques described herein relate to a method, wherein the input includes features extracted from text.

In some aspects, the techniques described herein relate to a method, wherein the text is derived from human speech.

In some aspects, the techniques described herein relate to a method, further including determining an overall prediction from a plurality of output predictions determined from different features extracted from the text.

In some aspects, the techniques described herein relate to a method, wherein each initial prediction includes a prediction class and a probability for the prediction class.

In some aspects, the techniques described herein relate to a method, wherein the probability is based upon the behavior of one of the plurality of prediction models and the input.

In some aspects, the techniques described herein relate to a method including: providing an input to a plurality of prediction models; obtaining, for the input, a prediction from each of the plurality of prediction models; determining a weight for each prediction from the plurality of prediction models; generating a training dataset including the input labeled with the weights for each of the predictions from the plurality of prediction models; and training a weight model using the training dataset.

In some aspects, the techniques described herein relate to a method, wherein determining the weight for each prediction includes determining the weight based upon a predetermined correct prediction for the input and the predictions from each of the plurality of prediction models.

In some aspects, the techniques described herein relate to a method, wherein the input includes features extracted from text.

In some aspects, the techniques described herein relate to a method, wherein the text includes text derived from human speech.

In some aspects, the techniques described herein relate to one or more tangible, non-transitory computer readable storage media encoded with instructions that, when executed by one or more processors, cause the one or more processors to: provide input to a plurality of prediction models; obtain an initial prediction from each of the plurality of prediction models; provide the input to one or more weight models; obtain from the one or more weight models a weight for each initial prediction, wherein the weight for each initial prediction is based upon the input and behavior of each of the plurality of prediction models; and determine an output prediction from the initial predictions and the weights.

In some aspects, the techniques described herein relate to one or more computer readable storage media, wherein each of the plurality of prediction models includes a machine learning model.

In some aspects, the techniques described herein relate to one or more computer readable storage media, wherein the one or more weight models includes a machine learning model.

In some aspects, the techniques described herein relate to one or more computer readable storage media, wherein the instructions operable to determine the output prediction include instruction operable to determine the output prediction by determining a plurality of weighted predictions by weighting each of the initial predictions with the respective weight for the initial prediction.

In some aspects, the techniques described herein relate to one or more computer readable storage media, wherein each initial prediction includes a prediction class and a probability for the prediction class.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method comprising:
providing input to a plurality of prediction models;
obtaining an initial prediction from each of the plurality of prediction models;
providing the input to one or more weight models;
obtaining from the one or more weight models a weight for each initial prediction, wherein the weight for each initial prediction is based upon the input and behavior of each of the plurality of prediction models; and
determining an output prediction from the initial predictions and the weights.

2. The method of claim 1, wherein each of the plurality of prediction models comprises a machine learning model.

3. The method of claim 1, wherein the one or more weight models comprises a machine learning model.

4. The method of claim 1, wherein determining the output prediction comprises determining a plurality of weighted predictions by weighting each of the initial predictions with the respective weight for the initial prediction.

5. The method of claim 4, wherein the output prediction comprises all of the weighted predictions.

6. The method of claim 4, wherein the output prediction comprises one of the weighted predictions.

7. The method of claim 1, wherein the input comprises features extracted from text.

8. The method of claim 7, wherein the text is derived from human speech.

9. The method of claim 7, further comprising determining an overall prediction from a plurality of output predictions determined from different features extracted from the text.

10. The method of claim 1, wherein each initial prediction comprises a prediction class and a probability for the prediction class.

11. The method of claim 10, wherein the probability is based upon the behavior of one of the plurality of prediction models and the input.

12. A method comprising:
providing an input to a plurality of prediction models;
obtaining, for the input, a prediction from each of the plurality of prediction models;
determining a weight for each prediction from the plurality of prediction models;
generating a training dataset comprising the input labeled with the weights for each of the predictions from the plurality of prediction models; and
training a weight model using the training dataset.

13. The method of claim 12, wherein determining the weight for each prediction comprises determining the weight based upon a predetermined correct prediction for the input and the predictions from each of the plurality of prediction models.

14. The method of claim 12, wherein the input comprises features extracted from text.

15. The method of claim 14, wherein the text comprises text derived from human speech.

16. One or more tangible, non-transitory computer readable storage media encoded with instructions that, when executed by one or more processors, cause the one or more processors to:
provide input to a plurality of prediction models;
obtain an initial prediction from each of the plurality of prediction models;
provide the input to one or more weight models;
obtain from the one or more weight models a weight for each initial prediction, wherein the weight for each initial prediction is based upon the input and behavior of each of the plurality of prediction models; and
determine an output prediction from the initial predictions and the weights.

17. The one or more computer readable storage media of claim 16, wherein each of the plurality of prediction models comprises a machine learning model.

18. The one or more computer readable storage media of claim 16, wherein the one or more weight models comprises a machine learning model.

19. The one or more computer readable storage media of claim 16, wherein the instructions operable to determine the output prediction comprise instruction operable to determine the output prediction by determining a plurality of weighted predictions by weighting each of the initial predictions with the respective weight for the initial prediction.

20. The one or more computer readable storage media of claim 16, wherein each initial prediction comprises a prediction class and a probability for the prediction class.
